(19) United States
(12) Patent Application Publication
(10) Pub. No.: US 2018/0073894 A1
(43) Pub. Date: Mar. 15, 2018

(54) ANGLE DETECTION METHOD AND ELECTRONIC DEVICE USING SAME

(71) Applicant: UBTECH Robotics Corp., Shenzhen (CN)

(72) Inventors: Zhenmin Mo, Shenzhen (CN); Tingshuang Huang, Shenzhen (CN); Youjun Xiong, Shenzhen (CN)

(21) Appl. No.: 15/397,730

(22) Filed: Jan. 4, 2017

(30) Foreign Application Priority Data
Sep. 9, 2016 (CN) 201610814351.5

(51) Int. Cl. G01D 5/00; H02K 11/21

(52) U.S. Cl. CPC G01D 5/00; H02K 11/21

(57) ABSTRACT

An angle detection method includes collecting as original sample of an object angle, determining whether the original sample jumps, smoothing the original sample and outputting a smoothed original sample as a pre-processed sample. The method further includes determining whether a transition period of the original sample passes, updating the original sample during the transition period to the pre-processed sample, filtering the pre-processed sample, and outputting a non-interference detection value.

### CROSS REFERENCE TO RELATED APPLICATIONS

This application claims priority to Chinese Patent Application No. 201610814351.5, filed Sep. 9, 2016, which is hereby incorporated by reference herein in its entirety.

### BACKGROUND

### 1. Technical Field

The present disclosure generally relates to sensor detection technology, and particularly to an angle detection method and an electronic device using the angle detection method.

### 2. Description of Related Art

An angle sensor is widely used in an electronic device, such as a servo of a smart robot. The servo is a key part of the smart robot as an actuating element. The servo includes the angle sensor and a controller. The angle sensor is configured to detect an angle value of an object, which is an output shaft of the servo. The controller is configured to control a rotation position of the output shaft according to the angle value and make the output shaft rotate to a target angle or keep at the target angle.

Generally, the servo includes an omni-directional angle sensor to detect the angle value of the output shaft from 0° to 360°. However, the omni-directional angle sensor may collect an inaccurate value with external interferences, sod a difference is generated between the target angle and an actual, angle of the rotation of the output shaft. To avoid the inaccurate value caused by external interferences, a mean value of a plurality of angle values serves as a detection value without interferences.

The omni-directional angle sensor can continuously collect a plurality of angle values which jump from 0° to 360° (that is positive jump) or jump from 360° to 0° (that is negative jump). If the mean value of a plurality of angle values which are continuously collected before and after jump serves as the detection value without interferences, the detection value may have a severe deviation with angle value before and after jump. The output shaft can generate a fluctuation under control of the controller according to the detection value and a deviation is generated between the actual angle of the output shaft and the target angle.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 a diagrammatic drawing of an electronic device.

FIG. 2 is a flowchart of an angle detection method according to one embodiment.

FIG. 3 is a flowchart of an angle detection method according to another embodiment.

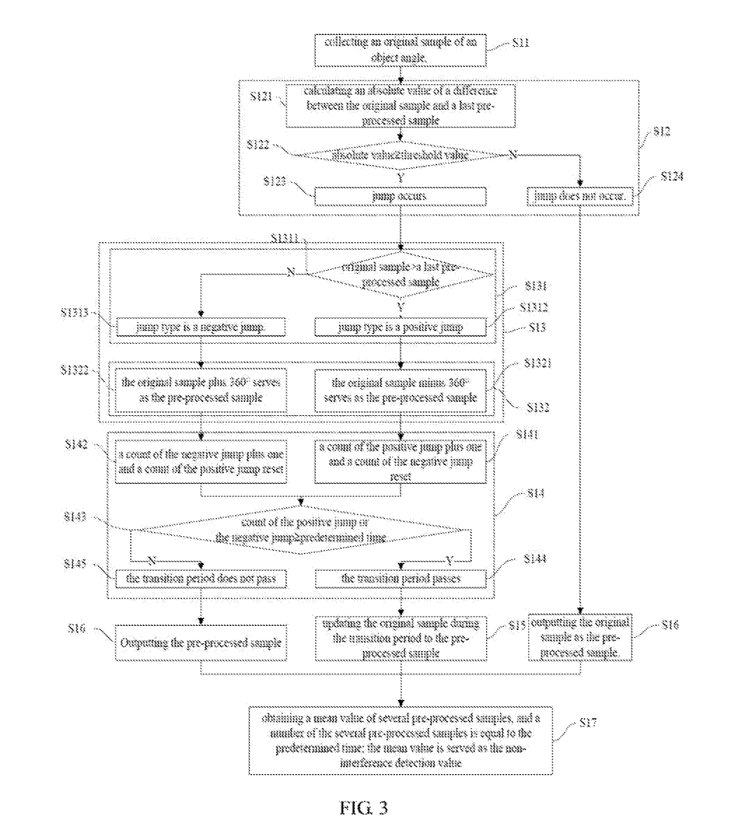

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

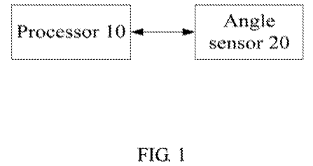

Referring to FIG. 1, an electronic device 1 can include a processor 30 and an angle sensor 20 coupled to the processor 10. The angle sensor 10 can collect an original sample of an object angle. The processor 20 performs an angle detection method to process the original sample and obtain an accurate sample. In the embodiment, the electronic device 1 can be a smart robot, which includes a plurality of servos and a controller. And the angle detection method is performed by the controller. Each servo can be a servo motor having an output shaft.

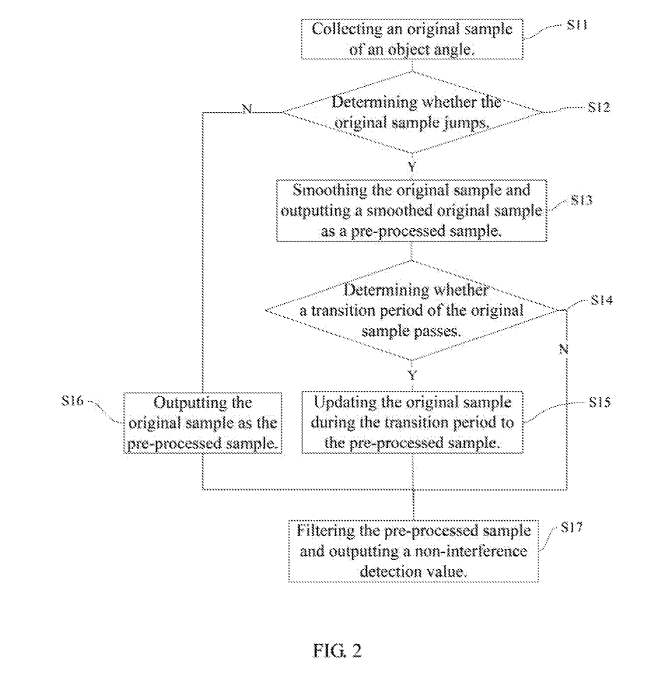

FIG. 2 shows a flowchart of an angle detection method according to one embodiment. Depending on the embodiment, additional steps may be added, others removed, and the ordering of the steps may be changed.

Step S11: Collecting an original sample of an object angle value. In the embodiment, the object angle value can be an angle value of the output shaft. The angle value is detected by an angle sensor, which, is an omni-directional angle sensor to avoid a blind area of the angle value. In the embodiment, each angle value detected by the angle sensor is stored in a storage of the servo.

Step S12: Determining whether the original sample jumps. That is, determining whether the original sample jumps from 0° to 360° or from 360° to 0°. In the embodiment, if the original sample jumps, the original sample is determined as a jumped original sample. The controller of the servo needs to determine whether the original sample jumps.

Step S12 can include a plurality of steps as below.

Step S121: Calculating an absolute value of a difference between one original sample and a last pre-processed sample.

Step S122: Determining whether the absolute value of the difference between the original sample and the last pre-processed sample is greater than or equal to a preset threshold value. In the embodiment, the threshold value can be 180° to determine whether the output shaft jumps from 0° to 360° (that is positive jump) or from 360° to 0° (that is negative jump).

Step S123: If the absolute value of the difference between the one original sample and the last pre-processed sample is greater than or equal to the preset threshold value, the one original sample jumps and Step S13 is performed. In the embodiment, a time interval between two original sample collections is small, unless the output shaft jumps from 0° to 360° or from 360° to 0° and the absolute value of the difference between the one sample and the last pre-processed sample will not be greater than or equal to the preset threshold value, thus when the output shaft jumps at a critical point, such as 0° and 360°, step S13 is performed.

Step S124: If the absolute value of the difference between the one original sample and the last pre-processed sample is less than the preset threshold value, the original sample does not jump and Step S16 is performed. In the embodiment, a time interval between two original samples is small, if the absolute value of the difference between the one original sample and the last pre-processed sample is less than the preset threshold value, the original sample does not jump from 0° to 360° and step S16 is performed.

Step S13: Smoothing the original sample and the smoothed original sample serves as the pre-processed sample. Specifically, smoothing the original sample can avoid a fluctuation of the output shaft affected by the jumped original sample. Step S13 can include a plurality of Steps.

Step S131: Determining a jump type of the original sample. As the original sample can jump from 0° to 360° or from 360° to 0°, determining the jump type is needed when the original sample jumps. Step S131 can include a plurality of steps.

Step S1311: Determining whether the original sample is greater than the last pre-processed sample, in the embodiment, determining whether the original sample jumps by comparing the absolute-value, of the difference between the one-original sample and the last pre-processed sample with the preset threshold value, so the jump type can be determined by comparing the original sample with last pre-processed sample.

Step S1312: If the original sample is greater than the last pre-processed sample, and the original sample is greater than or equal to a sum of the last pre-processed sample and the preset threshold value, the jump type is positive jump (jump from 0° to 360°), and step S132 is performed.

Step S1313: If the original sample is less than the last pre-processed sample, and the last pre-processed sample is greater than a sum of the original sample and the preset threshold value, the jump type is negative jump (jump from 360° to 0°), and step S132 is performed.

Step S132: Smoothing the original sample and the smoothed original sample serves as the pre-processed sample, and step S14 is performed. Specifically, smoothing the original sample can avoid a fluctuation of the output shaft affected by the jumped original sample. Step S132 can include a plurality of steps.

Step S1321: If the jump type is a positive jump (jump from 0° to 360°), the original sample minus 360° serves as the pre-processed sample. Thus an absolute value of the pre-processed sample is at around 0° and the pre-processed sample is close to the last pre-processed sample, which can achieve a smoothing transition to avoid the fluctuation of the output shaft affected by the jumped original sample.

Step S1322: If the jump type is a negative jump (jump from 360° to 0°), the original sample plus 360° serves as the pre-processed sample. Thus an absolute value of the pre-processed sample is at around 360° and the pre-processed sample is close to the last pre-processed sample, which can achieve a smoothing transition to avoid the fluctuation of the output shaft affected by the jumped original sample.

Step S14: Determining whether a jump transition period of the original sample passes. As the controller continuously processes several original samples, and determines whether the original sample jumps one by one. If the positive jump continuously occurs for predetermined times, the jump transition period of the original sample passes. If the negative jump continuously occurs for predetermined times, the jump transition, period of the original, sample passes. Step S14 includes a plurality of Steps.

Step S141: If the jump type is the positive jump, the count of the positive jump plus one and the count of the negative jump is reset.

Step S142: If the jump type is the negative jump, the count of the negative jump plus one and the count of the positive jump is reset. When the original sample does not jump, the counts of the positive jump and the negative jump are reset.

Step S143: Determining whether the count of the positive jump or the negative jump reaches for the predetermined times, respectively. In the embodiment, when jump times of the original sample reach the predetermined times, the transition period of the original sample passes.

Step S144: If the counts of the positive jump and the negative jump reaches for the predetermined times, respectively, the transition period of the original sample passes, and step S15 is performed. In the embodiment, if the positive jump occurs for predetermined times, the transition period of the positive jump passes; if the negative jump occurs for the predetermined times, the transition period of the negative jump passes.

Step S145, if the counts the positive jump and or the negative jump do not reach for the predetermined times, the transition period does not pass, and outputting the pre-processed sample of the original sample, step S17 is performed.

Step S15: If the transition period passes, updating the original sample during the transition period to the pre-processed sample, and step S17 is performed.

Step S16: If the original sample does not jump, replacing the original sample with the pre-processed sample, and step S17 is performed. In the embodiment, when the original sample does not jump, the original sample serves as the pre-processed sample. When the transition period passes, the original sample has smoothing transition; the original sample serves as the pre-processed sample.

Step S17: Filtering the pre-processed sample and outputting a non-interference detection value using a sliding filter. Specifically, obtaining a mean value of several continuous pre-processed samples, and the number of the several pre-processed samples is equal to the predetermined time. The mean value serves as the non-interference detection value, thus the controller can control the output shaft of the servo to rotate to the target angle or keep at the target angle. In the embodiment, the pre-processed sample can be the jumped original sample which does not pass the transition period and is not smoothed; also can be the jumped original sample which passes the transition period and updating the original sample during the transition period to the pre-processed sample; and also can be the original sample which does not jump.

In the embodiment, the preset threshold value can be 180°, the predetermined times can be five, that is the original sample continuously jumps from 0° to 360° for five times or from 360° to 0° for five times and then the transition period passes. The angle sensor continuously detects the angle value of the object for twenty times, which are shown in table 1 and 2, and the in the table 1 the non-interference detection value is rounded to two decimals.

As shown in table 1, as the non-interference detection value is equal to the mean value of the several pre-processed samples, and the number of the several pre-processed samples is equal to the predetermined times. In the embodiment, the non-interference detection value is the mean value of five pre-processed samples. As the data before the item 1 is missing, the non-interference detection value cannot be calculated in item 1 to item 4. As the original samples of items 5-7 of positive jump do not occur for five, the mean value of five pre-processed samples serves as the non-interference detection value. As shown in table 2, the jump counter of the original sample of the item 8 reaches for five during the positive jump, step 15 is performed, replacing five original samples with five pre-processed samples and step 17 is performed to obtain the non-interference detection value. As shown in table 2, the jump counter of the original sample of the items 9-17 during positive or negative jump does not reach for five, the mean value of five pre-processed samples serves as the non-interference detection value. As shown in table 2, the jump counter of the original sample of the item 18 reaches for live during the negative jump, step S15 is performed, and then replacing the five original samples with five pre-processed samples and step S17 is performed to obtain the non-interference detection value. The jump counter of the original sample of the items 19-20 during positive or negative jump does not reach for five, the mean value of live pre-processed samples serves as the non-interference detection value.

TABLE 1
(unit: degree)

| | | | | | Non- |
|---|---|---|---|---|---|
| | | Pre- | Count of | Counte of | interference |
| | Original | processed | positive | negative | detection |
| Item | sample | sample | jump | jump | value |
| 1 | 0.1 | 0.1 | 0 | 0 | — |
| 2 | 0.2 | 0.2 | 0 | 0 | — |
| 3 | 0.1 | 0.1 | 0 | 0 | — |
| 4 | 359.8 | −0.2 | 1 | 0 | — |
| 5 | 359.9 | −0.1 | 2 | 0 | 0.02 |
| 6 | 359.9 | −0.1 | 3 | 0 | −0.02 |
| 7 | 359.8 | −0.2 | 4 | 0 | −0.10 |
| 8 | 359.8 | −0.2 | 5 | 0 | |
| 9 | 359.9 | 359.9 | 0 | 0 | |
| 10 | 359.8 | 359.8 | 0 | 0 | |
| 11 | 359.9 | 359.9 | 0 | 0 | |
| 12 | 0.1 | 360.1 | 0 | 1 | |
| 13 | 359.8 | 359.8 | 1 | 0 | |
| 14 | 0.2 | 360.2 | 0 | 1 | 359.96 |
| 15 | 0.1 | 360.1 | 0 | 2 | 360.02 |
| 16 | 0.1 | 360.1 | 0 | 3 | 360.06 |
| 17 | 0.1 | 360.1 | 0 | 4 | 360.06 |
| 18 | 0.2 | 360.2 | 0 | 5 | |
| 19 | 0.2 | 0.2 | 0 | 0 | |
| 20 | 0.1 | 0.1 | 0 | 0 | |

TABLE 2
(unit: degree)

| | | | | | Non- |
|---|---|---|---|---|---|
| | | Pre- | Count of | Count of | interference |
| | Original | processed | positive | negative | detection |
| Item | sample | sample | jump | jump | value |
| 1 | 0.1 | 0.1 | 0 | 0 | — |
| 2 | 0.2 | 0.2 | 0 | 0 | — |
| 3 | 0.1 | 0.1 | 0 | 0 | — |
| 4 | 359.8 | 359.8 | 1 | 0 | — |
| 5 | 359.9 | 359.9 | 2 | 0 | 0.02 |
| 6 | 359.9 | 359.9 | 3 | 0 | −0.02 |
| 7 | 359.8 | 359.8 | 4 | 0 | −0.10 |
| 8 | 359.8 | 359.8 | 5 | 0 | 359.84 |
| 9 | 359.9 | 359.9 | 0 | 0 | 359.86 |
| 10 | 359.8 | 359.8 | 0 | 0 | 359.84 |
| 11 | 359.9 | 359.9 | 0 | 0 | 359.84 |
| 12 | 0.1 | 360.1 | 0 | 1 | 359.90 |
| 13 | 359.8 | 359.8 | 1 | 0 | 359.90 |
| 14 | 0.2 | 0.2 | 0 | 1 | 359.96 |
| 15 | 0.1 | 0.1 | 0 | 2 | 360.02 |
| 16 | 0.1 | 0.1 | 0 | 3 | 360.06 |
| 17 | 0.1 | 0.1 | 0 | 4 | 360.06 |
| 18 | 0.2 | 0.1 | 0 | 5 | 0.14 |
| 19 | 0.2 | 0.2 | 0 | 0 | 0.14 |
| 20 | 0.1 | 0.1 | 0 | 0 | 0.14 |

The angle detection method can determine whether the servo jumps from 0°to 360° or from 360° to 0° and smooth the original samples. Further, the angle detection method determine whether the transition period of the original sample passes, if the transition period passes, updating the all original samples during the transition period to the pre-processed samples and then filtering the pre-processed samples and outputting the non-interference detection value using the sliding filter. The angle detection method does not need to delete the jump sample to ensure the continuity of data, and can avoid a slosh phenomenon in the servo control; smoothing the jumped original sample to output the pre-processed sample, and when transition period of the original sample passes, the original samples during the transition period are updated to the pre-processed samples. And then filtering the pre-processed samples to ensure an accuracy and stability of the non-interference detection value.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

What is claimed is:

1. An angle detection method, comprising:
collecting an original sample of an object angle using an angle sensor;
responsive to determining that the original sample jumps, smoothing the original sample and outputting a smoothed original sample as a pre-processed sample;
responsive to determining that a transition period of the original sample passes, updating the original sample during the transition period to the pre-processed sample;
filtering the pre-processed sample and outputting a non-interference detection value using a sliding filter.

2. The angle detection method of claim 1, wherein responsive to determining that the original sample does not jump, outputting the original sample as the pre-processed sample;
responsive to determining that the transition period of the original sample does not pass, the pre-processed sample is outputted.

3. The angle detection method of claim 1, wherein responsive to determining that the original sample jumps comprises:
calculating an absolute value of a difference between the original sample and a last pre-processed sample;
determining whether the absolute value is greater than or equal to a preset threshold value;
wherein the original sample jumps if the absolute value is greater than or equal to the preset threshold value; and
wherein the original sample does not jump if the absolute value is less than the threshold value.

4. The angle detection method of claim 1, wherein smoothing the original sample and outputting a smoothed original sample as a pre-processed sample comprises:
determining a jump type of the original sample;
responsive to smoothing the original sample according to the jump type and outputting the smoothed original sample as the pre-processed sample.

5. The angle detection method of claim 4, wherein determining the jump type of the original sample comprises:
determining whether the original sample is greater than the last pre-processed sample;
wherein the jump type is a positive jump if the original sample is greater than the last pre-processed sample;
wherein the jump type is a negative jump if the original sample, is less than the last pre-processed sample.

6. The angle detection method of claim 5, wherein smoothing the original sample according to the jump type and outputting the smoothed original sample as the pre-processed sample comprises:
wherein the original sample minus 360° serves as the pre-processed sample, if the jump type is the positive jump;
wherein the original sample plus 360° serves as the pre-processed sample, if the jump type is the negative jump.

7. The angle detection method of claim 6, wherein determining that the transition period of the original sample passes comprises:
wherein a count of the positive jump plus one and a count of the negative jump is reset, if the jump type is the positive jump;
wherein a count of the negative jump plus one and a count of the positive jump is reset, if the jump type is the negative jump;
responsive to determining that the transition period of the original sample passes if the count of the positive jump or the negative jump reaches for a predetermined time;
responsive to determining that the transition period does not pass if the count of the positive jump and/or the negative jump do not reaches for the predetermined time.

8. The angle detection method of claim 7, wherein filtering the pre-processed sample and outputting a non-interference detection value using a sliding filter comprises:
obtaining a mean value of several continuous pre-processed samples, a number of the several pre-processed samples is equal to the predetermined time; the mean value serves as the non-interference detection value.

9. An electronic device, comprising:
at least one angle sensor detecting an original sample of an object angle;
a processor performing an angle detection method to process the original sample;
wherein the angle detection method comprises:
collecting an original sample of an object angle;
responsive to determining that the original sample jumps, smoothing the original sample and outputting a smoothed original sample as a pre-processed sample;
responsive to determining that a transition period of the original sample passes, updating the original sample during the transition period to the pre-processed sample;
filtering the pre-processed sample and outputting a non-interference detection value using a sliding filter.

10. The electronic device of claim 9, wherein responsive to determining that the original sample does not jump, outputting the original sample as the pre-processed sample;
responsive to determining that the transition period of the original sample does not pass, the pre-processed sample is outputted.

11. The electronic device of claim 9, wherein responsive to determining that the original sample jumps comprises:
calculating all absolute value of a difference between the original sample and a last pre-processed sample;
determining whether the absolute value is greater than or equal to a preset threshold value;
wherein the original sample jumps if the absolute value is greater than or equal to the preset threshold value; and
wherein the original sample does not jump if the absolute value is less than the threshold value.

12. The electronic device of claim 9, wherein smoothing the original sample and outputting a smoothed original sample as a pre-processed sample comprises:
determining a jump type of the original sample;
responsive to smoothing the original sample according to the jump type and outputting the smoothed original sample as the pre-processed sample.

13. The electronic device of claim 12, wherein determining the jump type of the original sample comprises:
determining whether the original sample is greater than the last pre-processed sample;
wherein the jump type is a positive jump if the original sample is greater than the last pre-processed sample;
wherein the jump type is a negative jump if the original sample is less than the last pre-processed sample.

14. The electronic device of claim 13, wherein smoothing the original sample according to the jump type and outputting the smoothed original sample as the pre-processed sample comprises:
wherein the original sample minus 360° serves as the pre-processed sample if the jump type is a positive jump;
wherein the original sample plus 360° serves as the pre-processed sample if the jump type is a negative jump.

15. The electronic device of claim 14, wherein responsive to determining that the transition period of the original sample passes comprises:
wherein a count of the positive jump plus one and a count of the negative jump is reset if the jump type is the positive jump;
wherein a count of the negative jump plus one and a count of the positive jump is reset if the jump type is the negative jump;
determining whether the count of the positive jump or the negative jump reach for a predetermined time;
responsive to determining that the transition period of the original sample passes, if the count of the positive jump or the negative jump reaches for the predetermined time;
responsive to determining that the transition period does not pass, if the count of the positive jump and/or the negative jump do not reach for the predetermined time,

16. The electronic device of claim 15, wherein filtering the pre-processed sample and outputting a non-interference detection value comprises:
obtaining a mean value of several continuous pre-processed samples, and a number of the several pre-processed samples is equal to the predetermined time; the mean value serves as the non-interference detection value.

17. The electronic device of claim 9, wherein the electronic device comprises a plurality of servos, the object angle is an angle value of an output shaft of each of servo.
